(19) United States
(12) Patent Application Publication
(10) Pub. No.: US 2025/0319528 A1
(43) Pub. Date: Oct. 16, 2025

(54) DOOR LOCK KIT INSTALLATION TOOL

(71) Applicant: Techtronic Cordless GP, Anderson, SC (US)

(72) Inventors: Trevor C. Fauss, Greenville, SC (US); Cayman M. Frederick, Bigfork, MT (US); Charles M. Wacker, II, Anderson, SC (US)

(21) Appl. No.: 19/175,108

(22) Filed: Apr. 10, 2025

Related U.S. Application Data
(60) Provisional application No. 63/633,080, filed on Apr. 12, 2024.

(51) Int. Cl. B23B 47/28

(52) U.S. Cl. CPC B23B 47/287

(57) ABSTRACT

Door lock installation kit tools, e.g., jigs, are provided. A door lock kit tool includes an edge wall including a first side, a second side opposite the first side, and an edge bore cavity that extends through the first and second sides, wherein the edge bore cavity defines a first axis that extends through the edge wall and through the first and second sides; a side wall adjacent the edge wall, the side wall including a first side, a second side opposite the first side, and a side wall cavity defined between the first and second sides. The tool further includes an insert at least partially positioned within the edge bore cavity or the side wall cavity, the insert being rotatable between a first position and a second position without removing the insert from within the edge bore cavity or side wall cavity. The insert includes an eccentrically oriented guide aperture.

### CROSS-REFERENCE TO RELATED APPLICATIONS

The present application claims priority to U.S. Provisional Patent Application Ser. No. 63/633,080 filed on Apr. 12, 2024, the disclosure of which is incorporated by reference herein in its entirety.

### FIELD

The present disclosure relates generally to door lock installation kits.

### BACKGROUND

Doors are often sold without door lock hardware and without the apertures required to install the door lock hardware. Typically, installing the door lock hardware requires the drilling or boring of a front face hole that passes through the door and an end wall hole that is perpendicular to the front face hole and intersects the front face hole. Locating these holes can be difficult and can require a number of measurements. In addition, it can be difficult to position the two holes at the proper elevation. Further, there are multiple standard door widths and multiple standard door latch lengths, so different combinations of doors and door latches require different measurements for both the front face hole and the end wall hole.

Accordingly, improved door lock installation kits are desired in the art. In particular, door lock installation kits which provide easy adjustability of both the front face hole and end wall hole without removal of the door lock installation kit from the door would be advantageous.

### BRIEF DESCRIPTION

Aspects and advantages of the present disclosure will be set forth in part in the following description, or may be obvious from the description, or may be learned through practice of the technology.

In accordance with one embodiment, a door lock kit tool is provided. The door lock kit tool includes an edge wall including a first side, a second side opposite the first side, and an edge bore cavity that extends through the first and second sides, wherein the edge bore cavity defines a first axis that extends through the edge wall and through the first and second sides; a side wall adjacent the edge wall, the side wall including a first side, a second side opposite the first side, and a side wall cavity defined between the first and second sides. The tool further includes an insert at least partially positioned within the edge bore cavity or the side wall cavity, the insert being rotatable between a first position and a second position without removing the insert from within the edge bore cavity or side wall cavity. The insert includes an eccentrically oriented guide aperture.

In accordance with another embodiment, a door lock kit tool is provided. The door lock kit tool includes an edge wall including a first side, a second side opposite the first side, and an edge wall cavity that extends through the first and second sides, wherein the edge wall cavity defines a first axis that extends through the edge wall and through the first and second sides; and a side wall adjacent the edge wall, the side wall including a first side, a second side opposite the first side, and a side wall cavity defined between the first and second sides. The tool further includes an edge bore insert at least partially positioned within the edge wall cavity, the edge bore insert being rotatable between a first position and a second position without removing the insert from within the edge wall cavity. The tool further includes a cross bore guide insert at least partially positioned within the side wall cavity, the cross bore insert being rotatable between a first position and a second position without removing the cross bore insert from within the side wall cavity.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a portion of a door in accordance with embodiments of the present disclosure;

FIG. 2 is a perspective view of a door lock kit tool in accordance with embodiments of the present disclosure;

FIG. 3 is a front view of a door lock kit tool with inserts removed in accordance with embodiments of the present disclosure;

FIG. 4A is a perspective view of an edge bore guide insert in accordance with embodiments of the present disclosure;

FIG. 4B is a front view of an edge bore guide insert in accordance with embodiments of the present disclosure;

FIG. 4C is a side view of an edge bore guide insert in accordance with embodiments of the present disclosure;

FIG. 5 is a perspective view of a door lock kit tool with inserts remove in accordance with embodiments of the present disclosure;

FIG. 6 is a perspective view of a cross bore guide insert in accordance with embodiments of the present disclosure; and

FIG. 7 is a perspective view of a door lock kit tool in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has.” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present invention is directed to a door lock installation kit tool, or jig, that is configurable for multiple standard door widths (i.e., 1⅜ inches or 1¾ inches), and multiple standard door hardware backset distances (i.e., 2⅜ inches or 2¾ inches) and can be adjusted without removing the tool from a door. The door lock installation kit tool includes an edge bore guide insert and a cross bore guide insert which may be rotatably adjusted within the tool to adjust the respective door width and backset distance. Eccentric openings within each insert may provide guides for drilling into the door at the proper door width and backset distance for a particular door and door hardware set.

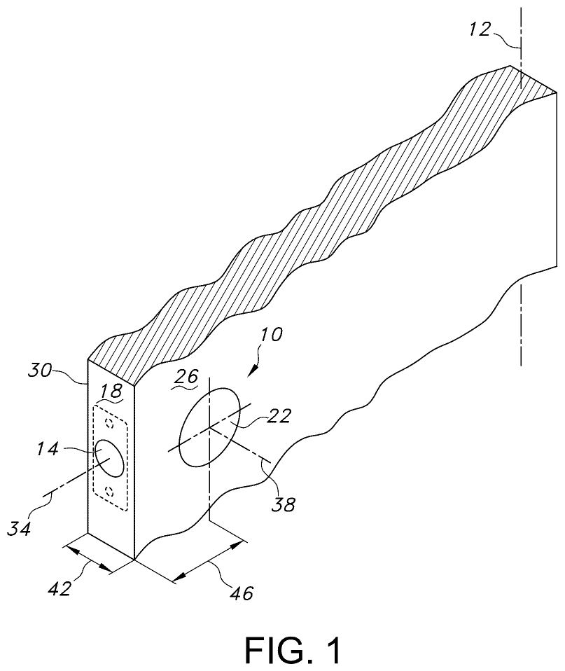

Referring now to the drawings, FIG. 1 illustrates a portion of a door 10 into which door hardware, such as a door lock, a door latch and knob assembly, or a deadbolt assembly, may be installed. The door includes a longitudinal axis 12. Installing the door hardware typically requires an edge bore 14 (also referred to as a latch bore) to be drilled into a latch edge 18 of the door 10 and a cross bore 22 to be drilled through the door 10 through a first side 26 and a second side 30 of the door 10. An edge bore axis 34 extends through a center point of the edge bore 14, and a cross bore axis 38 extends through a center point of the cross bore 22. The edge bore axis 34 is substantially normal to and coplanar with the cross bore axis 38. The edge bore 14 intersects the cross bore 22 inside the door 10. When properly positioned, the plane containing the edge bore axis 34 and the cross bore axis 38 will be substantially perpendicular to the latch edge 18 and the longitudinal axis 12 of the door 10. The edge bore 14 is centered along a width 42 of the latch edge 18. Typical doors 10 have a latch edge width 42 between 1⅜ inches and 1¾ inches. A backset 46 (i.e., the distance from the latch edge 18 to the center point of the cross bore 22) is typically 2⅜ inches or 2¾ inches, depending on the door hardware. The edge bore 14 and the cross bore 22 must also be properly positioned vertically on the door 10. For example, for a door 10 having a height of 80 inches, it may be desirable to position the centers of the edge bore 14 and cross bore 22 at a height of about 36 inches. A door hardware locating tool is used to ensure that the edge bore 14 and the cross bore 22 are properly positioned on the door 10.

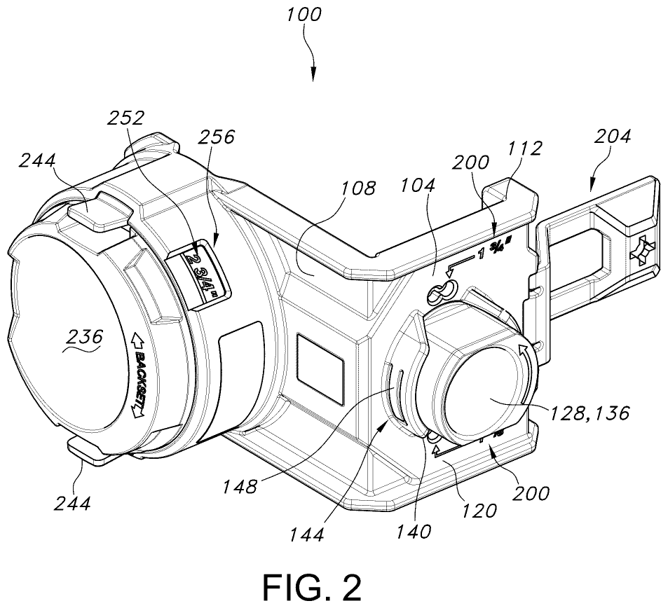

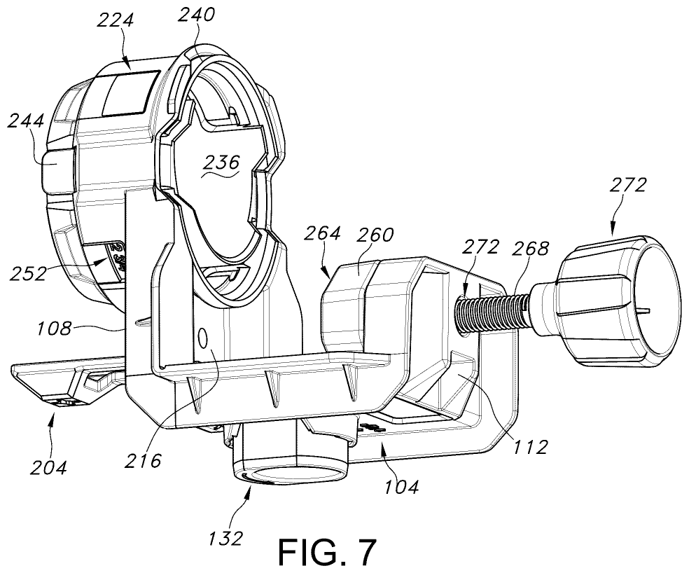

FIGS. 2-7 illustrate a door lock kit tool 100. The door lock kit tool 100 may also be referred to as a door lock kit jig. The tool 100 includes an edge wall or center wall 104, a first wall 108, and a second wall 112. The first wall 108, the second wall 112, and the edge wall 104 may be formed as a unitary body. In other words, the first wall 108, the second wall 112, and the edge wall 104 may be formed, e.g., integrally formed, from a single piece of material, such as by molding or any other suitable manufacturing method. The first wall 108 and the second wall 112 extend substantially perpendicularly from the edge wall 104. In the illustrated embodiment, the walls 104, 108, 112 are made of plastic, with other materials also being suitable.

With continued reference to FIGS. 2-4, the edge wall 104 includes a first side 120, a second side 124 opposite the first side 120, and an edge wall cavity 128 extending through the first and second sides 120, 124. The edge wall cavity 128 is configured to receive an edge bore guide insert 132. The edge bore guide insert 132 includes an edge bore guide aperture 136 which functions as an edge bore locator, and the center of the edge bore guide aperture 136 defines an edge bore axis 138. The edge bore guide aperture 136 may be circular and is eccentrically located in the edge bore guide insert 132. The edge bore guide aperture 136 is sized to receive a cutting tool, such as a hole saw or a drill bit, that is the proper size for creating the latch bore 14. In other embodiments, the edge bore guide aperture 136 could be larger than the desired latch bore size, and adapters that match standard latch bore sizes could be provided for insertion into the aperture 136.

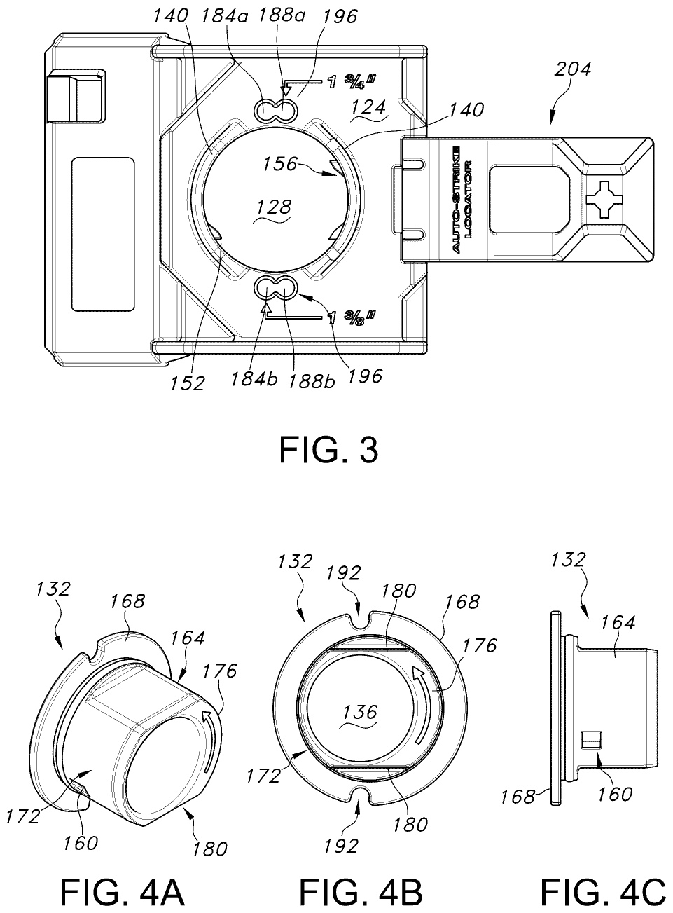

As shown in FIGS. 2-3, the edge wall cavity 128 may include guide walls 140 surrounding at least a portion of the cavity 128 and protruding from the first side 120. Each guide wall 140 may include an engagement tab 144 configured to couple with the edge bore guide insert 132. The engagement tabs 144 may include an arm 148 having a protrusion 152 at an end thereof. Each protrusion 152 may have a ramped surface 156 configured to engage with a complementary recess 160 in an outer surface of the edge bore guide insert 132 (see FIGS. 4A and 4C). Each ramped surface 156 may be angled in a same direction so that the edge bore guide insert 132 may be rotated within the cavity 128 in the direction of the ramp, i.e., in a single direction. For instance, the edge bore guide insert 132 may be configured to rotate only in a direction opposite of a direction of drilling. In some aspects, the engagement tabs 144 may be located about 180 degrees about the edge wall cavity 128 from each other. In this arrangement, the edge bore guide insert 132 may be rotated between two orientations by rotating the insert 132 by about 180 degrees within the cavity 128. However, it is to be understood that any suitable number of tabs 144 and complementary recesses 160 may be provided, and the respective pairs of tabs 144 and complementary recesses 160 may be provided at any suitable arrangement about the circumference of the cavity 128.

The edge bore guide insert 132 is formed by a guide body 164 having an ob-round guide section and a flange 168 at one end thereof. The edge bore guide aperture 136 extends through the ob-round guide section. The edge bore guide aperture 136 is eccentrically oriented in the ob-round guide section, i.e., is located off-center within the ob-round guide section. The ob-round guide section has a first rounded side 172, a second rounded side 176, and first and second opposing flat sides 180. The first rounded side 172 may have a first wall thickness and the second rounded side may have a second wall thickness that is greater than the first wall thickness. In this manner, the edge bore guide aperture 136 is arranged off-center, i.e., eccentrically oriented. In some aspects, the second rounded side 176 may include a visual indicator for indicating the direction of rotation, such as with an arrow printed, imprinted, molded, or otherwise formed in or on the edge bore guide insert 132. The opposing first and second flat sides 180 may provide a grip for a user to rotate the edge bore guide insert 132. Additionally, the opposing first and second flat sides 180 may be configured to extend generally horizontally, e.g., generally parallel to an upper and a lower edge of the door, when the edge bore guide insert 132 is locked into one of the orientations.

The guide body 164 of the edge bore guide insert 132 may extend through the cavity 128 of the edge wall 104 from the second side 124 towards the first side 108. The flange 168 may be configured to contact the second side 124. The flange 168 may have a diameter that is larger than a diameter of the cavity 128 the edge bore guide insert 132 is held in place against the second side 124 of the edge wall 104 by a face of the flange 168 contacting or abutting the second side 124.

The edge wall 104 may include fastener guide openings for receiving a fastener, e.g., screw, to affix the jig 100 to the door 10. For instance, a first pair of fastener guide openings 184a, 184b may be aligned above and below, respectively the edge bore guide insert 132 and configured for centering the edge bore guide insert 132 for a first door width. A second pair of fastener guide openings 188a, 188b may be aligned above and below the edge bore guide insert 132 and configured for centering the edge bore guide insert 132 for a second door width. The flange 168 may have cut-outs 192 configured to align with one of the pairs of fastener guide openings 184a-b, 186a-b and block the other pair of fastener guide openings when the edge bore guide insert 132 is aligned for the first door width or second door width. In this arrangement, the flange 168 may cover the incorrect door thickness fastener guide openings and allow access to the correct fastener guide openings for a respective door width. In some aspects, although not required, the respective upper fastener guide openings may overlap each other to create a single “FIG. 8” shaped aperture 196, and the respective lower fastener guide openings may overlap each other to create a single “FIG. 8” shaped aperture 196.

In some aspects, the edge wall 104 and the edge bore guide insert 132 may include one or more indicia to visually indicate to a user which door thickness the edge bore guide insert 132 is set for. For instance, the edge wall 104 may include one or more visual indicia 200 that may be printed, imprinted, molded, or otherwise formed in or on the first wall 120 and inform a user of the door thickness the edge bore guide insert 132 is set for. In some aspects, the one or more visual indicia 200 may point to the fastener guide openings 196. For instance, the first door width may be indicated on the first side 120 with an indicator, e.g., an arrow, to at least one of the first pair of fastener guide openings 184a-b, and the second door width may be indicated on the first side 120 with an indicator, e.g., an arrow, to at least one of the second pair of fastener guide openings 188a-b.

In some aspects, a strike plate locator 204 may be coupled to the edge wall 104. For instance, the strike plate locator 204 may be coupled to the first side 120 of the edge wall 104. The strike plate locator 204 is configured to be extended and aligned with a strike plate of a door frame (not shown) to position the jig 100 at the proper elevation on the door 10.

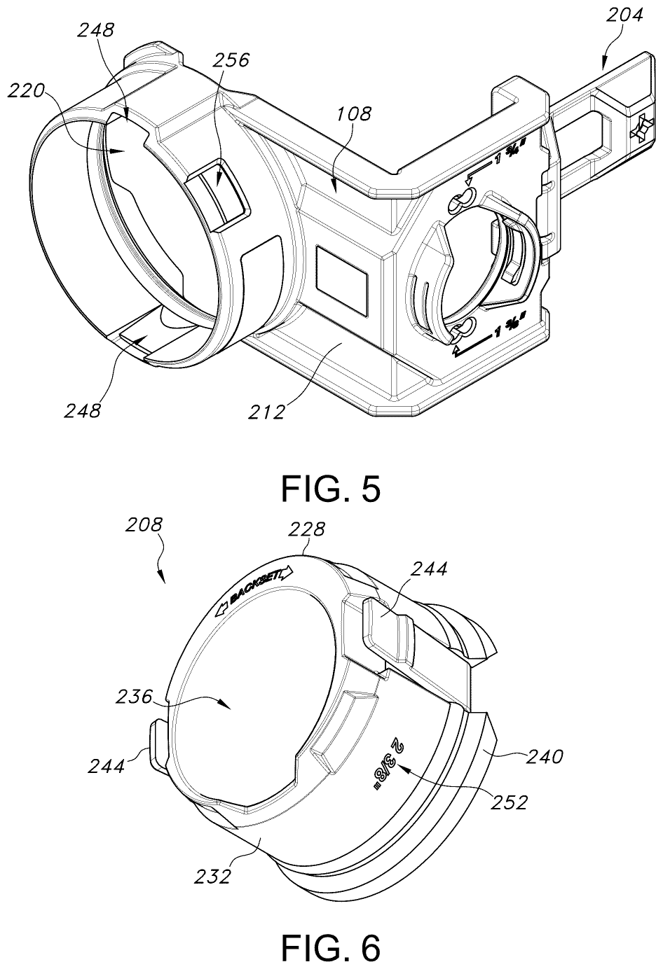

Turning now to FIGS. 5-7, the first wall 108 is configured to receive a cross bore guide insert 208. The first wall 108 includes a first side 212 adjacent to the first side 120 of the edge wall 104 and a second side 216 adjacent to the second side 124 of the edge wall 104. A first wall cavity 220 is formed through the first wall 108 from the first side 212 to the second side 216. In some aspects, a guide wall 224 may extend outward from the first side 212 of the first wall 108 surrounding some or all of the cavity 220. For instance, the guide wall 224 may extend generally perpendicularly from the first side 212 of the first wall 108 in a direction away from the second side 216. The cross bore guide insert 208 is configured to be disposed within the cavity 220. For instance, the cross bore guide insert 208 may be inserted through the cavity 220 from the second side 216 toward the first side 212 within the guide wall 224.

The cross bore guide insert 208 is formed from a cross bore guide body 228. The cross bore guide body 228 may have a generally circular guide section 232. A cross bore guide aperture 236 is formed through the cross bore guide body 228, e.g., surrounded by the generally circular outer wall. The cross bore guide aperture 236 may have a circular shape. The cross bore guide aperture 236 is eccentrically oriented in the guide section 232, i.e., is located off-center within the generally circular guide section 232 such that a center point of the cross bore guide aperture 236 and a center point of a generally circular outer periphery of the guide section 232 are not the same.

The cross bore guide body 228 may further include a flange 240 at an end of the guide section 232. The flange 240 may have a diameter larger than a diameter of the cavity 220 of the first wall 108 so that the cross bore guide insert 208 may be inserted into the cavity 220 and the flange 240 may be seated against the second side 216 to retain the cross bore guide insert 208 in place relative to the cavity 220.

In some aspects, as illustrated in FIGS. 5-6, the guide section 232 and the guide wall 224 may include one or more complementary coupling features to retain the cross bore guide insert 208 in place at a relative rotational position within the guide wall 224. For instance, the guide section 232 may include one or more tabs 244 extending outward therefrom in a radial direction, and the guide wall 224 may include one or more complementary recesses 248 configured to receive a tab and prevent rotation of the insert 208. For example, the tab(s) 244 may be pinch tabs, e.g., cantilevered spring tabs having living hinges and extending axially along the guide body 228 and coupled adjacent to the flange 240. When the tab(s) 244 are compressed or pinched radially inward by a user, the guide cross bore guide insert 208 may be rotated within the guide wall 224, and the tab(s) 244 may snap radially outward in place at the recess(es) 248 of the guide wall 224.

In some aspects of the present invention, two tabs may be provided on the insert 208 and two recesses may be provided in the guide wall 224. The respective tabs and recesses may be disposed generally opposite each other about a circumference. For instance, the recesses 248 may be generally located at a top and a bottom point of the circular guide wall 224, or at any other suitable locations. In the cross bore guide insert 208, the tabs may be generally equidistantly spaced between a thinnest and thickest point of the guide body 232 relative to the eccentric orientation of the guide aperture 236. In this arrangement, when the guide insert 208 is secured in place relative to the guide wall 224 at either backset distance, a center point of the cross bore guide aperture 236 and a center point of the first wall cavity 220 may be generally aligned in a horizontal direction. Moreover, the tabs 244 can be compressed inward and the cross bore guide insert 208 can be rotated between backset distances while the cross bore guide insert 208 remains within the guide wall 224, i.e., without removing the cross bore guide insert 208 from the jig 100. In some aspects, the cross bore guide insert 208 may be able to be rotated in either a clockwise or a counterclockwise direction, e.g., based on a user's preference.

In some aspects, the first wall 108 and the cross bore guide insert 208 may include one or more indicia to visually indicate to a user which backset measurement the cross bore guide insert 208 is set for. For instance, the cross bore guide insert 208 may include one or more visual indicia 252 that may be printed, imprinted, molded, or otherwise formed in or on the insert 208 and inform a user of the backset that the cross bore guide insert 208 is set for. In some aspects, the one or more visual indicia 252 may be arranged on an outer circumference of the guide body 232. The first wall 108, e.g., the guide wall 224, may include an indicator window 256 (also referred to as a viewing window) through which the one or more visual indicia 252 may be visible to a user. The visual indicia 252 may be arranged on the guide body 232 spaced apart at intervals adapted to be viewed through the indicator window 256 when the cross bore guide insert 208 is disposed at a predetermined rotational position that corresponds to a specified backset distance. For instance, when the cross bore guide insert 208 is configured to adjust between two distinct backset distances, the first backset distance and second backset distance may be arranged on the guide body 232 about 180 degrees apart about the circumference of the guide body 232.

In some aspects, the jig 100 may include a clamping mechanism 116. For instance, the clamping mechanism 116 may be coupled with the second wall 112, opposite the first wall 108. The clamping mechanism 116 may include an engagement body 260 having an engagement surface 264 configured to engage with (i.e., contact) a second side 30 of the door 10, opposite the first side 26 on which the first wall 108 is arranged when the jig 100 is in use. The engagement body 260 may be arranged at an inner side, i.e., second side, of the second wall 112. A threaded member 268 may extend from the engagement body 260 opposite the engagement surface 264. The threaded member 268 may extend through the second wall 112. For instance, a complementary threaded opening 272 may be provided through the second wall 112. A grip 276 may be provided at an opposite end of the threaded member 268. The grip 276 may be configured to enable a user to rotate the threaded member 268 clockwise or counterclockwise to move the engagement body 260 closer to or away from the second surface 30 of the door. In this manner, the jig 100 can be positioned at a desired position relative to the door, then the user may actuate the clamping mechanism 116 to secure the engagement surface 264 against the second side 30 of the door to hold the jig 100 in place. The clamping mechanism 116 may be especially useful for holding the jig 100 in place relative to a door made from a material that would be more challenging to fasten the jig 100 to using fasteners, e.g., a metal door.

Further aspects of the disclosure are provided by one or more of the following embodiments:

A door lock kit tool includes an edge wall including a first side, a second side opposite the first side, and an edge bore cavity that extends through the first and second sides, wherein the edge bore cavity defines a first axis that extends through the edge wall and through the first and second sides; a side wall adjacent the edge wall, the side wall including a first side, a second side opposite the first side, and a side wall cavity defined between the first and second sides. The tool further includes an insert at least partially positioned within the edge bore cavity or the side wall cavity, the insert being rotatable between a first position and a second position without removing the insert from within the edge bore cavity or side wall cavity. The insert includes an eccentrically oriented guide aperture.

The door lock kit of any one or more of the embodiments, wherein the insert comprises an edge bore insert positioned within the edge bore cavity.

The door lock kit of any one or more of the embodiments, wherein the first position is configured to center the eccentrically oriented guide aperture for a door width of 1⅜ inches and the second position is configured to center the eccentrically oriented guide aperture for a door width of 1¾ inches.

The door lock kit of any one or more of the embodiments, wherein the insert comprises a cross bore insert positioned within the side wall cavity.

The door lock kit of any one or more of the embodiments, wherein the first position corresponds to a backset distance of 2⅜ inches and the second position corresponds to a backset distance of 2¾ inches.

The door lock kit of any one or more of the embodiments, wherein the insert comprises an edge bore insert positioned within the edge bore cavity, the tool further comprising a cross bore insert positioned within the side wall cavity.

The door lock kit of any one or more of the embodiments, further comprising at least one visual indicator configured to indicate if the insert is in the first position or the second position.

The door lock kit of any one or more of the embodiments, the visual indicator comprising a viewing window formed through the edge wall or the side wall.

The door lock kit of any one or more of the embodiments, the insert further comprising a flange configured to abut the second side of the edge wall or the second side of the side wall.

The door lock kit of any one or more of the embodiments, further comprising a securing mechanism configured to secure the insert in the first position or the second position.

The door lock kit of any one or more of the embodiments, the side wall comprising a guide wall extending from the first side of the side wall, the guide wall surrounding at least a portion of the side wall cavity.

The door lock kit of any one or more of the embodiments, wherein the side wall is a first side wall and the tool further comprises a second side wall adjacent the edge wall and substantially parallel to the first side wall.

The door lock kit of any one or more of the embodiments, further comprising a clamping mechanism configured to secure a door between the first side wall and the second side wall.

The door lock kit of any one or more of the embodiments, wherein the first side wall, the second side wall, and the edge wall are integrally formed.

The door lock kit of any one or more of the embodiments, wherein the edge wall and the side wall are substantially perpendicular.

A door lock kit tool includes an edge wall including a first side, a second side opposite the first side, and an edge wall cavity that extends through the first and second sides, wherein the edge wall cavity defines a first axis that extends through the edge wall and through the first and second sides; and a side wall adjacent the edge wall, the side wall including a first side, a second side opposite the first side, and a side wall cavity defined between the first and second sides. The tool further includes an edge bore insert at least partially positioned within the edge wall cavity, the edge bore insert being rotatable between a first position and a second position without removing the insert from within the edge wall cavity. The tool further includes a cross bore guide insert at least partially positioned within the side wall cavity, the cross bore insert being rotatable between a first position and a second position without removing the cross bore insert from within the side wall cavity

The door lock kit of any one or more of the embodiments, wherein the edge bore insert is rotatable in a single direction.

The door lock kit of any one or more of the embodiments, wherein the cross bore insert is rotatable in a counterclockwise or a clockwise direction.

An apparatus as shown and described in one or more embodiments herein.

A system configured to operate in accordance with any one or more embodiments disclosed herein.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A door lock kit tool comprising:
an edge wall including a first side, a second side opposite the first side, and an edge bore cavity that extends through the first and second sides, wherein the edge bore cavity defines a first axis that extends through the edge wall and through the first and second sides;
a side wall adjacent the edge wall, the side wall including a first side, a second side opposite the first side, and a side wall cavity defined between the first and second sides; and
an insert at least partially positioned within the edge bore cavity or the side wall cavity, the insert being rotatable between a first position and a second position without removing the insert from within the edge bore cavity or side wall cavity, the insert including an eccentrically oriented guide aperture.

2. The door lock kit of claim 1, wherein the insert comprises an edge bore insert positioned within the edge bore cavity.

3. The door lock kit of claim 2, wherein the first position is configured to center the eccentrically oriented guide aperture for a door width of 1⅜ inches and the second position is configured to center the eccentrically oriented guide aperture for a door width of 1¾ inches.

4. The door lock kit of claim 1, wherein the insert comprises a cross bore insert positioned within the side wall cavity.

5. The door lock kit of claim 4, wherein the first position corresponds to a backset distance of 2⅜ inches and the second position corresponds to a backset distance of 2¾ inches.

6. The door lock kit of claim 1, wherein the insert comprises an edge bore insert positioned within the edge bore cavity, the tool further comprising a cross bore insert positioned within the side wall cavity.

7. The door lock kit of claim 1, further comprising at least one visual indicator configured to indicate if the insert is in the first position or the second position.

8. The door lock kit of claim 7, the visual indicator comprising a viewing window formed through the edge wall or the side wall.

9. The door lock kit of claim 1, the insert further comprising a flange configured to abut the second side of the edge wall or the second side of the side wall.

10. The door lock kit of claim 1, further comprising a securing mechanism configured to secure the insert in the first position or the second position.

11. The door lock kit of claim 1, the side wall comprising a guide wall extending from the first side of the side wall, the guide wall surrounding at least a portion of the side wall cavity.

12. The door lock kit of claim 1, wherein the side wall is a first side wall and the tool further comprises a second side wall adjacent the edge wall and substantially parallel to the first side wall.

13. The door lock kit of claim 12, further comprising a clamping mechanism configured to secure a door between the first side wall and the second side wall.

14. The door lock kit of claim 12, wherein the first side wall, the second side wall, and the edge wall are integrally formed.

15. The door lock kit of claim 1, wherein the edge wall and the side wall are substantially perpendicular.

16. A door lock kit tool comprising:
an edge wall including a first side, a second side opposite the first side, and an edge wall cavity that extends through the first and second sides, wherein the edge wall cavity defines a first axis that extends through the edge wall and through the first and second sides;
a side wall adjacent the edge wall, the side wall including a first side, a second side opposite the first side, and a side wall cavity defined between the first and second sides;
an edge bore insert at least partially positioned within the edge wall cavity, the edge bore insert being rotatable between a first position and a second position without removing the insert from within the edge wall cavity; and
a cross bore guide insert at least partially positioned within the side wall cavity, the cross bore insert being rotatable between a first position and a second position without removing the cross bore insert from within the side wall cavity.

17. The door lock kit of claim 16, wherein the edge bore insert is rotatable in a single direction.

18. The door lock kit of claim 16, wherein the cross bore insert is rotatable in a counterclockwise or a clockwise direction.
